(19) United States
(12) Patent Application Publication
(10) Pub. No.: US 2012/0193006 A1
(43) Pub. Date: Aug. 2, 2012

(54) PNEUMATIC TIRE

(75) Inventor: Yoshio Ueda, Kanagawa (JP)

(73) Assignee: THE YOKOHAMA RUBBER CO., LTD., MINATO-KU, TOKYO (JP)

(21) Appl. No.: 13/497,122

(22) PCT Filed: Oct. 15, 2010
(86) PCT No.: PCT/JP2010/068120

§ 371 Date: Mar. 20, 2012

(30) Foreign Application Priority Data
Oct. 16, 2009 (JP) 2009-239753
Mar. 29, 2010 (JP) 2010-075053

(51) Int. Cl. B60C 9/18; B60C 9/00

(52) U.S. Cl. 152/451; 152/527

(57) ABSTRACT

A steel cord having a 1×2 construction formed by twisting two wire strands together is used as a reinforcing layer of a pneumatic tire. The steel cord has a carbon content of from 0.60 to 0.75%, a strength in the tire of from 2,900 to 3,500 MPa, and a twisting angle of from 1.5 to 3.0°. Therefore, productivity can be enhanced while fatigue resistance of the steel cord used in the reinforcing layer is maintained. Additionally, fatigue resistance of the steel cord is further enhanced due to the average value of the forming factor of the steel cord of this tire being set to from 95 to 105% and the standard deviation σ being set to from 5 to 20%. As a result, tire durability can be enhanced.

### TECHNICAL FIELD

The present technology relates to a pneumatic tire and particularly relates to a pneumatic tire in which productivity is enhanced while fatigue resistance of a steel cord used in a reinforcing layer is maintained. More specifically, the present technology relates to a pneumatic radial tire which is capable of displaying enhanced tire durability.

### RELATED ART

Conventionally, in order to obtain high strength (e.g. 2,900 MPa or greater), high-carbon steel (HCS) having a carbon content of more than 0.75%, the HCS being configured in a 1×2×0.30HT twisted construction (see, for example, Patent Documents 1, 2, and 3) has been used as the steel cord for use in belt layers of pneumatic tires.

For example, Patent Document 1 describes a pneumatic radial tire including a wire material having a carbon content of 0.82 weight %, a cord angle of 23%, and 47.25 cord ends (per 50 mm) in order to maintain the belt folding of a belt layer using a steel cord having a 1×2×0.30HT twisted construction and the separation durability of the belt layer.

As described above, conventionally, a 1×2×0.30HT construction has been used for the steel cord for use as the belt of passenger car tires, but in recent years, there has been a demand for a tire that displays enhanced fatigue resistance of the steel cord along with extended life of the tire. As a result, various proposals regarding configurations of the steel cord have been made (see Patent Documents 4, 5, and 6).

In Patent Document 4 (filed by the present applicant), a reinforcing layer is formed from a steel cord having a 1×2 construction, wherein two wire strands premolded in a helical state are twisted together. A length of a twist phase of the steel cord p₁ is greater than or equal to a length of a helical phase of the premolded wire strands p₂ (p₂≦p₁), and a height of a twist phase d₁ is greater than a height of the helical phase of the premolded wire strands d₂ and is three times or less than a diameter D of the wire strands (d_{2 1}≦3D). Patent Document 4 describes that, as a result of this configuration, excellent bending fatigue resistance and compression fatigue resistance can be obtained due to enhanced permeability of the covering rubber of the steel cord and reduced fretting.

Additionally, in Patent Document 5 (filed by the present applicant) a 1×2 single-strand cord construction is used for a steel cord of the outermost belt layer. Patent Document 5 describes that weight can be reduced and, simultaneously, both rust resistance and shock resistance can be enhanced by configuring a forming factor of the wire strands of the steel cord to be 105% or greater, a twisting pitch to be 20 times or less than a diameter d of the wire strands, and a rupture elongation of cords extracted from the tire to be 4% or greater.

Additionally, Patent Document 6 describes a configuration in which when θ is a twisting angle of a steel cord used as a reinforcing member and D is a core layer diameter, a minimum twisting pitch Pmin satisfies the formula Pmin=πD·tan [(90−θ)θ/180]. Furthermore, when R is a curvature radius of a cord when in use and L is a cut length of the cord, a maximum twisting pitch Pmax satisfies the lesser of either PM r=2πR or PM l=L. Patent Document 6 describes that by applying such a configuration, a load on the cord is made uniform along the entire cord regardless of being in a bent state, twisting reduction is minimal, and high strength can be obtained, thus enabling the forming of a long-pitched steel cord with a large elongation ratio.

### PRIOR ART DOCUMENTS

### Patent Documents

Patent Document 1: Japanese Unexamined Patent Application Publication No. 562-234921A
Patent Document 2: Japanese Unexamined Patent Application No. H03-193983A
Patent Document 3: Japanese Unexamined Patent Application Publication No. 2000-178887A
Patent Document 4: Japanese Unexamined Patent Application No. H05-124403A
Patent Document 5: Japanese Unexamined Patent Application No. H05-147404A
Patent Document 6: Japanese Unexamined Patent Application No. H09-132885A

### SUMMARY OF THE INVENTION

### Problems to be Solved by the Invention

However, there is a drawback in that intermediate wire drawing productivity is poor because the high carbon content steel used in Patent Documents 1 to 3 is hard and a high machining ratio cannot be obtained when wire drawing.

In order to solve this problem, there are methods for performing heavy processing in which soft steel rods having a low carbon content and by which a high wire drawing ratio can be obtained, are used in order to increase the intermediate wire drawing ratio. Thereby, because orientation of the steel structure increases, a steel cord strength of a level equivalent to that reached when high carbon content steel is used can be obtained. However, even if the strength is equivalent to that of conventional high carbon content steel cords, because the steel material is soft, the wire elements in the 1×2 twisted construction steel cord experience point contact during use. Therefore, declining of the fatigue resistance of the steel cord has been a problem.

In Patent Document 4, the length and the height of the twist phase of the 1×2 construction steel cord, the length and the height of the helical phase of the wire strands, and the wire strand diameter are set to satisfy the relationships described above. Therefore, while configured so that space between the two wire strands is sufficiently large, permeability of the covering rubber is enhanced and fretting is reduced, and bending fatigue resistance and compression fatigue resistance of the steel cord does not decline, there is a problem in that fatigue resistance enhancement cannot be said to be sufficient because the twisting angle and forming factor of the steel cord are not appropriately stipulated.

Additionally, in Patent Document 5, by configuring the forming factor, the twisting pitch, and the like of the 1×2 construction steel cord so as to satisfy the relationships describe above, substantially an entirety of a periphery of the wire strands is covered with rubber, weight is reduced, and simultaneously, rust resistance and shock resistance are made to be excellent. However, there is a problem in that fatigue resistance enhancement cannot be said to be sufficient because the twisting angle of the steel cord is not appropriately stipulated and the stipulation of the forming factor is not sufficient as well.

Additionally, while Patent Document 6 describes that a long-pitched steel cord can be formed by setting the twisting pitch within a predetermined range, conventional twisting angles of 3.8° or 3.85° for a 1×2 construction steel cord are the only angles described. Patent Document 6 does not describe reducing the twisting angle and/or increasing the twisting length, or appropriately stipulating the forming factor. Therefore, there is a problem in that fatigue resistance enhancement cannot be said to be sufficient.

Furthermore, in order to enhance the fatigue resistance of the 1×2 construction steel cord, a configuration in which the twisting length of the steel cord is increased and the wire strands are in “line contact” instead of “point contact”, thereby reducing the space between the wire strands and enhancing the permeability of the covering rubber has been considered. However, when only the twisting length is increased, there is a problem in that the wire strands will move individually and readily rub against each other, causing fretting friction because the line contacting portions are not covered by rubber, thereby resulting in fatigue resistance not being enhanced.

Therefore, with the conventional technologies described above, there has been a problem in that the tire durability of a pneumatic radial tire using a 1×2 construction steel cord as a reinforcing layer could not be enhanced.

An object of the present technology is to resolve the problems of the conventional technology described above and provide a pneumatic tire that makes increased productivity possible while maintaining the fatigue resistance of a steel cord used in a reinforcing layer.

Another object of the present technology, in addition to the object stated above, is to provide a pneumatic tire that makes possible the enhancing of the fatigue resistance of the steel cord and, thereby, the enhancing of tire durability by appropriately stipulating a twisting angle, as well as an average value and a standard deviation σ for a forming factor of a 1×2 construction steel cord used in a pneumatic radial tire.

### Means to Solve the Problems

In order to achieve the objects described above, the pneumatic tire of the present technology is a pneumatic tire including a reinforcing layer wherein a steel cord having a 1×2 construction formed by twisting two wire strands together is used, wherein a carbon content of the steel cord is from 0.60 to 0.75%, a strength of the steel cord in the tire is from 2,900 to 3,500 MPa, and a twisting angle of the steel cord is from 1.5 to 3.0°.

Here, a thickness of a brass plating layer formed on an outer surface of the wire strands of the steel cord is preferably from 0.25 to 0.32 μm.

Additionally, a diameter of the wire strands of the steel cord is preferably from 0.28 to 0.35 mm.

Moreover, a twisting length of the steel cord is preferably from 18 to 40 mm.

Furthermore, the reinforcing layer is preferably a belt layer and/or a side wall reinforcing layer.

Additionally, in order to achieve the objects described above, an average value of a forming factor of the steel cord is preferably from 95 to 105% and a standard deviation σ is preferably from 5 to 20%.

Moreover, at least one wire strand of the two wire strands of the steel cord is preferably subjected to minor forming.

Furthermore, the pneumatic tire is preferably a pneumatic radial tire.

### Effect of the Invention

According to the present technology, in a pneumatic tire using a steel cord having a 1×2 twisted construction as a reinforcing layer, the steel cord has a carbon content of from 0.60 to 0.75% and, therefore is soft; productivity can be enhanced due to being able to increase the machining ratio when wire drawing; and, moreover, strength from 2,900 to 3,500 MPa, which is equivalent to that of conventional high-carbon content steel cords, can be obtained because heavy processing which results in high orientation is possible. Additionally, because the twisting angle is from 1.5 to 3.0°, there will be no point contacting between the wire strands in the steel cord, rather contacting will be closer to line contacting. Therefore, point contacting of the wire strands can be prevented and the fatigue resistance of the steel cord can be enhanced.

In other words, for example, compared to the pneumatic tire of Patent Document 1, wherein a steel cord is used in which heavy processing of a low carbon content wire material and reducing of the twisting angle is not provided, the present technology is superior with regards to fatigue resistance and productivity of the steel cord of a pneumatic tire.

Additionally, according to the present technology, in addition to the effect described above, the twisting angle of the steel cord is reduced, which leads to the wire strands being brought into line contact, and the standard deviation σ of the forming factor is increased and localized spaces through which the rubber can permeate are formed, which leads to the enhancing of rubber permeability. Therefore, individual movement and mutual rubbing of the wire strands accompanying the reducing of the twisting angle is prevented, the forming factor (average value) is limited to around 100%, instability of the form of the cord is eliminated, the elastic modulus is prevented from decreasing, and, as a result, tire durability can be enhanced.

### BRIEF DESCRIPTION OF THE DRAWINGS

FIG. 1 is a cross-sectional view illustrating a right half, with respect to a center line CL, of an embodiment of a pneumatic tire according to the present technology.

FIG. 2 is a schematic view illustrating an embodiment of a steel cord for use in the present technology.

FIG. 3A is an explanatory drawing illustrating a cord outer diameter of a 1×2 construction steel cord. FIG. 3B is an explanatory drawing illustrating a helical outer diameter of a single wire strand when extracted individually.

### DETAILED DESCRIPTION

The pneumatic tire of the present technology is described below in detail based on a preferred example illustrated in the attached drawings.

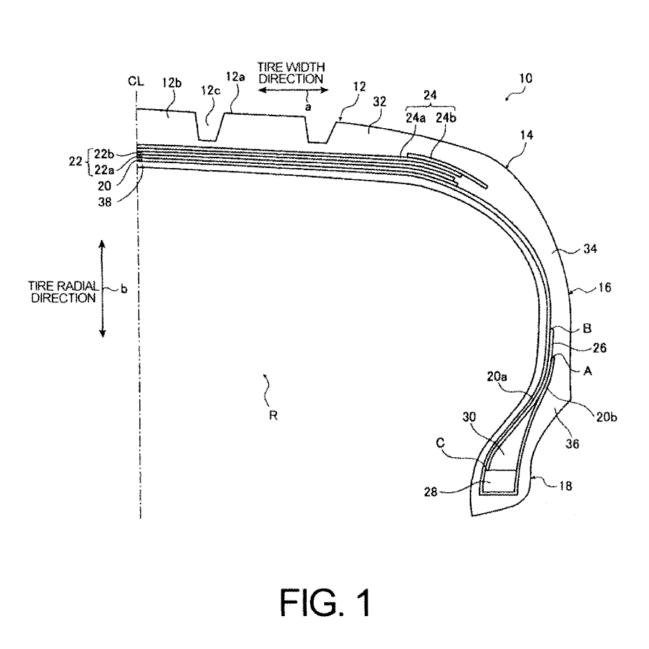

FIG. 1 is a cross-sectional view illustrating a right half, with respect to a center line CL, of an embodiment of a pneumatic tire of the present technology.

### First Embodiment

A pneumatic tire illustrated in FIG. 1 (hereinafter referred to as simply “tire”) 10 is a pneumatic radial tire including a tread portion 12, a shoulder 14, a side wall portion 16, and a bead portion 18 as major constituents. A left side of the tire that is not illustrated in FIG. 1 has the same configuration as the right side.

In the following description, “tire width direction” refers to a direction parallel to a rotational axis of the tire as indicated by arrow a in FIG. 1, and “tire radial direction” refers to a direction orthogonal to the rotational axis as indicated by arrow b. Additionally, “tire circumferential direction” refers to a rotating direction with the rotational axis as the axis at the center of rotation. Furthermore, “tire inner side” refers to a lower side in the tire radial direction of the tire in FIG. 1, or, rather, a side on an inner surface of the tire that faces a cavity region R that provides a predetermined inner pressure to the tire. “Tire outer side” refers to an upper side of the tire in FIG. 1, or, rather, a side on an outer surface of the tire (a side opposite the tire inner circumferential surface) that is viewable by a user.

The tire 10 mainly includes a carcass layer 20, a belt layer 22, a belt cover layer 24, a side wall reinforcing layer 26, a bead core 28, a bead filler 30, a tread rubber layer 32, a side wall rubber layer 34, a rim cushion rubber layer 36, and an inner liner rubber layer 38. As described above, the left side of the tire that is not illustrated in FIG. 1 has the same configuration as the right side.

With the tire 10 of the present technology illustrated in FIG. 1, the carcass layer 20 is mounted between a pair of right and left bead portions 18,18 and each end in the tire width direction of the carcass layer 20 is folded over and up from a tire inner side to a tire outer side around respective bead cores 28. The belt layer 22 formed from two layers of steel cords is disposed on an outer circumferential side of the carcass layer 20 in the tread portion 12 so that the reinforcing cords cross between the layers. Additionally, the side wall reinforcing layer 26 formed from a steel cord is provided in a region spanning from the side wall portion 16 to the bead portion 18 along an outer side of a folded over end of the carcass layer 20.

Hereinafter, each of the constituents of the tire 10 will be described in detail.

Land portions 12b forming a tread surface 12a of the tire outer side and tread grooves 12c formed in the tread surface 12a are provided in the tread portion 12. The land portions 12b are defined by the tread grooves 12c. The tread grooves 12c include main grooves formed continuously in the tire circumferential direction and a plurality of lug grooves (not illustrated) extending in the tire width direction. A tread pattern is formed in the tread surface 12a by the tread grooves 12c and the land portions 12b.

The carcass layer 20 forms the skeleton of the tire and extends in the tire width direction, from a portion corresponding to the tread portion 12 through portions corresponding to the shoulder 14 and the side wall portion 16 to the bead portion 18. The carcass layer 20 has a configuration in which reinforcing cords formed from organic fibers are arranged at a fixed spacing facing a single direction, for example the tire width direction, and are covered with a cord coating rubber. The carcass layer 20 is folded over the pair of left and right bead cores 28 (described below) from the tire inner side to the tire outer side to form an end portion A in a region of the side wall portion 16, and is formed from a main portion 20a and a folded over portion 20b that are delimited by the bead core 28. The left side of the tire that is not illustrated in FIG. 1 has an end portion identical to the right side.

The belt layer 22 is attached in the tire circumferential direction, is a reinforcing layer for reinforcing the carcass layer 20, and is a reinforcing layer to which the present technology is applied. The belt layer 22 is provided between the left and right shoulders 14 at a position corresponding to the tread portion 12 and includes a first belt 22a on an inner side and a second belt 22b on an outer side. In this embodiment, both the first belt 22a and the second belt 22b of the belt layer 22 have a configuration where the reinforcing cords formed from the steel cord to which the present technology is applied are arranged at a fixed spacing facing a direction that is inclined with respect to the tire circumferential direction, and are covered with the cord coating rubber (hereinafter referred to as “coating rubber”).

The steel cord that is the characteristic of the present technology and that constitutes the reinforcing cords of the first belt 22a and the second belt 22b is described in detail below.

Additionally, in this embodiment, the steel cord of the present technology is applied to both the first belt 22a and the second belt 22b of the belt layer 22, but the present technology is not limited thereto and the steel cord of the present technology may be applied to only one of the first belt 22a and the second belt 22b of the belt layer 22. If the steel cord of the present technology is applied to the side wall reinforcing layer 26 described below, the steel cord of the present technology is not applied to either of the first belt 22a or the second belt 22b of the belt layer 22, rather, a conventional steel belt or conventional reinforcing cord made from an organic fiber cord including polyester, nylon, aromatic polyamides, or the like may be used.

The belt cover layer 24 is provided on the tire outer side of the belt layer 22 and covers from one end to the other end of the belt layer 22 in the tire width direction, and includes organic fibers that reinforce the belt layer 22. As long as the belt cover layer 24 can reinforce the belt layer 22 the belt cover layer 24 may be configured so as to cover only a portion of the belt layer 22.

For example, as illustrated in FIG. 1, the tire 10 is configured with a belt cover layer 24 that includes a layer 24a that covers the belt layer 22 from one end to the other end in the tire width direction and a layer 24b on an outer side of the layer 24a that covers an end of the belt layer 22.

The bead core 28 around which the carcass layer 20 is folded and that functions to fix the tire 10 to the wheel is provided in the bead portion 18. Additionally, the bead filler 30 is also provided in the bead portion 18 so as to contact the bead core 28. Therefore, the bead core 28 and the bead filler 30 are sandwiched by the main portion 20a and the folded over portion 20b of the carcass layer 20.

Additionally, the side wall reinforcing layer 26 that includes the reinforcing cords inclined with respect to the tire circumferential direction is embedded in the bead portion 18.

In this embodiment, the side wall reinforcing layer 26 is disposed between the main portion 20a of the carcass layer 20 and the bead filler 30 at the bead portion 18, and between the main portion 20a and the folded over portion 20b of the carcass layer 20 at the side wall portion 16; and extends from the bead core 28 to an end portion B of the of the shoulder 14 side, farther along the tire radial direction than the end portion A of the folded over portion 20b.

Note that another end portion C of the side wall reinforcing layer 26 extends in the vicinity of the bead core 28 between the main portion 20a of the carcass layer 20 and the bead filler 30. Additionally, the side wall reinforcing layer 26 may be disposed between the folded over portion 20b of the carcass layer 20 and the bead core 28 and/or the bead filler 30 at the bead portion 18, and between the main portion 20a and the folded over portion 20b at the side wall portion 16; or on an outer side in the tire width direction of the folded over portion 20b at the bead portion 18 and on an outer side of the main portion 20a at the side wall portion 16. Furthermore, the side wall reinforcing layer 26 may be disposed in combinations of these configurations.

The side wall reinforcing layer 26 has a configuration where the reinforcing cords formed from the steel cord to which the present technology is applied are arranged at a fixed spacing facing a direction that is inclined with respect to the tire circumferential direction, and are covered with the cord coating rubber. Note that the steel cord that is the characteristic of the present technology and that constitutes the reinforcing cords of the side wall reinforcing layer 26 is described in detail below.

Additionally, in this embodiment, the steel cord of the present technology is applied to the side wall reinforcing layer 26, but the present technology is not particularly limited thereto. If the steel cord of the present technology is applied to the belt layer 22 as described above, the steel cord of the present technology is not applied to the side wall reinforcing layer 26, rather, a conventional steel belt or conventional reinforcing cord made from an organic fiber cord including polyester, nylon, aromatic polyamides, or the like may be used.

As long as the side wall reinforcing layer 26 can reinforce the side (side wall) of the tire 10, in other words, the bead portion 18 and/or the side wall portion 16, the side wall reinforcing layer 26 may be provided on an entirety or a portion of the bead portion 18 and/or the side wall portion 16. Moreover, a position of the end portion is not limited. For example, the end portion of the side wall reinforcing layer 26 may be extended to a region contacting the belt layer 22 of the shoulder 14 and be provided on an entirety of the bead portion 18 and the side wall portion 16. Alternately, the end portion of the side wall reinforcing layer 26 may be provided only on the bead portion 18 or only on the side wall portion 16; or, for example, may be divided into multiple portions and provided separately on the bead portion 18 and the side wall portion 16.

Furthermore, the region where the side wall reinforcing layer 26 is provided may be changed according to the type of reinforcing cord that is used. For example, when using the steel cord according to the present technology or a conventional steel cord as the reinforcing cord of the side wall reinforcing layer 26, the side wall reinforcing layer 26 is preferably disposed between the bead filler 30 and the folded over portion 20b of the carcass layer 20; and when using an organic fiber cord, the side wall reinforcing layer 26 is preferably disposed so as to envelop the bead core 28 and the bead filler 30.

The tire 10 includes the tread rubber layer 32 that constitutes the tread portion 12, the side wall rubber layer 34 that constitutes the side wall portion 16, the rim cushion rubber layer 36, and the inner liner rubber layer 38 provided on the tire inner circumferential surface as other rubber materials.

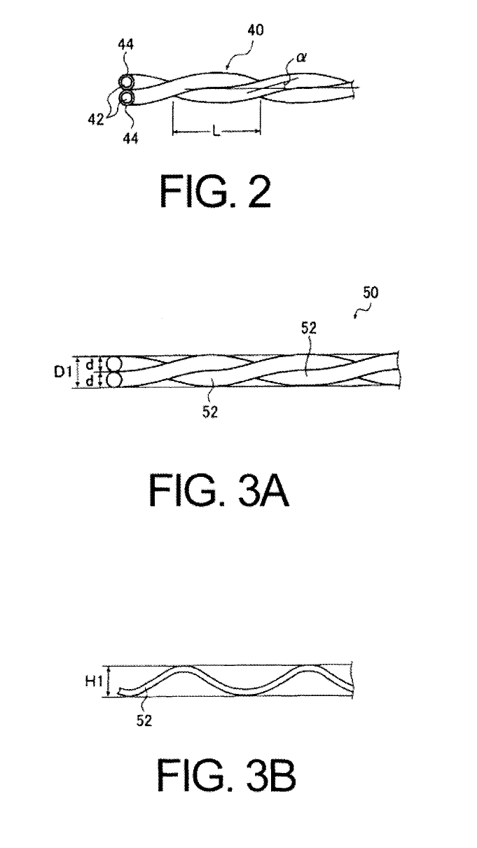

In the first embodiment of the present technology, as illustrated in FIG. 2, a steel cord 40 used as the reinforcing cords of the belt layer 22 has a 1×2 twisted construction formed by twisting two wire strands 42 together at a fixed pitch. The steel cord 40 is configured so as to have a carbon content of from 0.60 to 0.75%, a strength of from 2,900 to 3,500 MPa when embedded in the tire 10, and a twisting angle α of from 1.5 to 3.0°.

The steel cord 40 having the configuration described above can be manufactured by the method described below.

A steel rod having a carbon content of from 0.60 to 0.75% and a diameter of about from 5.5 to 6.0 mm is used as a raw material. First, this low carbon content steel rod is wire drawn to form a semi-finished wire rod having a diameter of approximately 2.0±0.02 mm. Then, the semi-finished wire rod is brass plated. This brass plating functions as a bonding layer with the rubber and as a lubrication layer when performing final wire drawing. Next, a wire strand having a diameter of approximately from 0.28 to 0.35 mm is formed by subjecting the brass plated semi-finished wire rod to wire drawing where a degree of final wire drawing is relatively large at 3.8 or greater. Furthermore, two of the wire strands are aligned and twisted at a relatively small twisting angle of from 1.5 to 3.0°. Thus, a steel cord having a strength in the tire of from 2,900 to 3,500 MPa and a 1×2 twisted construction can be obtained.

Advanced machining with high productivity can be performed because a steel cord having a low carbon content is used in the wire drawing described above. Additionally, because heavy processing is performed that results in a large difference in the diameter at final wire drawing of 3.8 or greater, a wire strand having a high strength at 2,900 MPa or greater can be obtained, and the steel cord having a 1×2 twisted construction can be configured so as to have a strength of from 2,900 to 3,500 MPa. Moreover, because the thick semi-finished wire rod can be wire drawn and molded into a wire strand without reducing the machining speed, the semi-finished wire rod and the plated wire can be thickened and the machining efficiency (weight per unit time) can be improved.

If the carbon content of the steel cord 40 is less than 0.60%, the steel cord 40 will be excessively soft and fatigue resistance will be negatively affected. If the carbon content exceeds 0.75%, the steel cord 40 will be hard, which leads to a need for reduced speed machining and thus, a decrease in productivity. In other words, if the semi-finished wire rod is not narrowed, different from the case of the present technology described above, final wire drawing will require an extended period of time, and moreover, machining efficiency of the semi-finished wire rod will decline due to narrowing the semi-finished wire rod, and plating efficiency will also decline.

The steel cord 40 of the present technology is configured so as to have a strength of from 2,900 to 3,500 MPa when embedded in the tire 10 and to maintain strength at a level equal to that of conventional cords. If the strength is less than 2,900 MPa, tire durability will decline as a result of a reduction in the strength of the tire reinforcing layer. On the other hand, if the strength exceeds 3,500 MPa, wire breakage will be facilitated and tire durability will decline as a result of a decline in the ductility of the wire.

Because the steel cord 40 of the present technology has a low carbon content and is soft, there is a problem in that if used as-is, the wire strands 42 will contact each other during use and be prone to breakages occurring at points of contact. However, because the twisting angle α is set to a low range of from 1.5 to 3.0°, the wire strands 42 will be more in line contact rather than point contact in cases where the wire strands 42 contact each other. Therefore, breakage caused by point contact between the wire strands 42 can be prevented. If the twisting angle α of the steel cord 40 in the tire is less than 1.5°, gatherability will decline and the form of the cord will become unstable, which will lead to tire durability being negatively affected. On the other hand, if the twisting angle α exceeds 3.0°, the wire strands 42 will become prone to point contacting, and breakage caused by point contacting will be facilitated.

Here, the twisting angle α is an angle formed by the cord longitudinal direction and the wire strands 42 and is a value found by applying a layer core diameter R that is found by subtracting a wire strand diameter Rw from a cord diameter Rc (Rc−Rw), and a twisting length L per 1 twisting pitch to the formula α=180/π×tan⁻¹[π×R/L).

Additionally, the wire strands 42 of the steel cord 40 are preferably configured so as to have a diameter of from 0.28 to 0.35 mm. If the diameter of the wire strands 42 is less than 0.28 mm, productivity will not be able to be improved. On the other hand, if the diameter of the wire strands 42 exceeds 0.35 mm, the fatigue resistance of the wire will not be able to be maintained.

The brass plating layer 44 formed on the outer surfaces of the wire strands 42 of the steel cord 40 are preferably configured so as to have a thickness of from 0.25 to 0.32 μm. If the thickness of the brass plating layer 44 is less than 0.25 μm, the material of the wire strands 42 will be prone to localized exposure, which leads to the tire durability being negatively affected. On the other hand, if the thickness of the brass plating layer 44 exceeds 0.32 μm, the bonding layer of the brass plating layer 44 will become brittle and prone to separating from the rubber, which leads to the tire durability being negatively affected.

Additionally, along with the twisting angle described above, it is further preferable that the twisting length L of the steel cord 40 be from 18 to 40 mm. If the twisting length L is less than 18 mm, it will not be possible to prevent breakages caused by point contacting of the wire strands 42. On the other hand, if the twisting length L exceeds 40 mm, the form of the cord will become unstable due to a decline in gatherability.

The steel cord 40 having the configuration described above can be used similarly for other reinforcing layers such as the side wall reinforcing layer 26 and the like in addition to being used for the belt layer 22.

The pneumatic tire according to the first embodiment of the present technology, in general, is configured as described above.

### Second Embodiment

In addition to the configuration of the pneumatic tire of the first embodiment, a pneumatic tire of a second embodiment of the present technology, by appropriately stipulating the twisting angle of the steel cord and the average value and the standard deviation σ of the forming factor, can further enhance the fatigue resistance of the steel cord while maintaining the productivity achieved through the first embodiment, without negatively affecting the improvement thereof and, as a result, can enhance the durability of the tire.

Note that the pneumatic tire of the second embodiment of the present technology has a configuration that is identical to that of the first embodiment with the exceptions of the twisting angle of the steel cord and the average value and standard deviation σ of the forming factor. Thus, descriptions of identical aspects of the configuration have been omitted and, mainly, aspects that differ are described.

In the second embodiment of the present technology, a steel belt is described that is exemplary of the present technology and that is used as the first belt 22a and the second belt 22b of the belt layer 22 and as the side wall reinforcing layer 26.

This embodiment uses a steel cord, having a 1×2 construction formed by twisting two wire strands (hereinafter referred to simply as “wire strands”) together, as a reinforcing layer of a tire, wherein a carbon content of the steel cord is from 0.60 to 0.75%, a strength of the steel cord when embedded in the tire is from 2,900 to 3,500 MPa, a twisting angle (twisting angle α) of the steel cord in the tire is from 1.5 to 3.0 degrees, and an average value of a forming factor of the steel cord is from 95 to 105% and a standard deviation σ thereof is from 5 to 20%.

Note that the carbon content of the steel cord, the strength of the steel cord when embedded in the tire, and the twisting angle α (hereinafter referred to simply as “twisting angle”) of the steel cord in the tire are the same as in the first embodiment. Therefore, description thereof is omitted.

In the tire, when a cord outer diameter of the steel cord, when the two wire strands are concentrically twisted leaving no space, is 100, the forming factor of the steel cord having a single-twisted 1×2 construction formed by twisting two wire strands together is defined by a helical outer diameter of a single wire strand when extracted individually therefrom.

Specifically, a steel cord 50 illustrated in FIG. 3A is formed by twisting two wire strands 52 together without leaving any space. Therefore, a cord outer diameter D1 of the steel cord 50 is two-times a diameter d (wire strand diameter), of one of the wire strands 52, or 2d, where D1=2d. For example, with a 1×2×0.30HT steel cord a wire strand diameter d is 0.30 mm so a cord outer diameter D1 is 0.60 mm (0.30×2).

On the other hand, even when the steel cord 50 is formed by twisting two of the wire strands 52 together without leaving any space, when each of the twisted two wire strands 52 is individually extracted, as illustrated in FIG. 3B, the wire strand 52 has a helical shape. However, because it has expanded or contracted from when in a twisted state, a helical outer diameter H1, which is the outer diameter of the envelope of the helix, is a predetermined value. By finding the helical outer diameter H1 and applying it to the formula (H1/D1)×100, the forming factor of the steel cord can be determined.

Note that in this embodiment, the forming factor of the steel cord, specifically the average value (AVG) and the standard deviation σ of the forming factor, can be calculated by following, for example, the process below:

1) Extract the steel cord from the tire.

2) Using a utility knife, remove the rubber from the outer side of the steel cord.

3) Immerse the steel cord in acetone (until the cord can be disassembled easily), and apply heat.

4) Taking care not to cause plastic deformation of the wire strand, disassemble the steel cord and separate the wire strands.

5) Using a projector, measure four consecutive wave heights (mm) of one of the wire strands at a portion positioned at the tire center.

6) Taking H1 as an average value of the four consecutive wave heights and D1 as the cord outer diameter calculated in advance from the wire strand diameter, find the forming factor (%) from the formula (H1/D1)×100.

7) Using the same method, find the forming factor of the other wire strand.

8) Conduct the same test for eight positions on a periphery of the tire.

9) Find the forming factors for eight of the steel cords (thus, 16 of the wire strands), and calculate the forming factor (AVG, σ) of the steel cord.

Thus, the average value (AVG) and the standard deviation σ of the forming factor can be calculated.

Additionally, the twisting angle of the steel cord can be calculated by following the process below:

1) Extract the steel cord from the tire.

2) Using a utility knife, remove the rubber from the outer side of the steel cord.

3) Measure the cord diameter and twisting length.

4) Disassemble the steel cord and remove the rubber between the wire strands using a utility knife.

5) Measure the wire strand diameter.

6) Conduct the same test for eight positions on a periphery of the tire.

7) Using the following formula, calculate the twisting angle of the eight steel cords and find the average value of the twisting angles.

Twisting angle (angle α)=180/π×arctan(π×layer core diameter/twisting length)

Layer core diameter=cord diameter−wire strand diameter

In this embodiment as well, the twisting angle α of a steel cord having a conventional 1×2 construction is reduced, for example, from having a twisting angle of 3.9 degrees at a twisting length of 14 mm to a twisting angle of from 1.5 to 3.0 degrees, and, thereby, the wire strands are brought into line contact. However, when the wire strands are brought into line contact, the wire strands are prone to move individually and rub against each other. Therefore, by stipulating the forming factor, in particular, by stipulating a large standard deviation σ of the forming factor of the steel cord that is from 5 to 20%, forming localized spaces through which the covering rubber can permeate, and increasing the permeability of the covering rubber, individual movement and mutual rubbing of the wire strands can be prevented. Moreover, negative effects on the fatigue resistance of the steel cord due to instability of the form of the steel cord and/or a decrease of the initial elastic modulus of the steel cord are prevented. Therefore, tire durability is enhanced.

Thus, in this embodiment as well, the twisting angle of the steel cord is limited to within a range of from 1.5 to 3.0 degrees. The reason for this is, as described above, that when the twisting angle of the steel cord is less than 1.5 degrees, the form of the cord becomes unstable, and when the twisting angle of the steel cord exceeds 3.0 degrees, an effect of enhancing tire durability over that of a conventional steel cord having a 1×2 construction cannot be obtained.

Additionally, in this embodiment, it is necessary to limit the average value (AVG) of the forming factor of the steel cord to from 95 to 105%. The reason for this is because, while the permeation of the rubber in the spaces between the wire strands is facilitated when the forming factor (AVG) is great, the elastic modulus decreases. Specifically, when the forming factor (AVG) is less than 95%, the form of the steel cord becomes unstable, the fatigue resistance of the steel cord decreases, and the tire durability is negatively affected. When the forming factor (AVG) is greater than 105%, the initial elastic modulus of the steel cord decreases and the tire durability is negatively affected.

Moreover, in this embodiment, it is necessary to limit the standard deviation σ of the forming factor of the steel cord to from 5 to 20%. The reason for this is because, when the standard deviation σ of the forming factor is great, localized spaces through which the coating rubber can permeate are formed and permeability of the coating rubber is enhanced. Thereby, the generation of fretting friction due to individual moving and mutual rubbing of the wire strands can be prevented. Specifically, when the standard deviation σ of the forming factor is less than 5%, the localized spaces through which the coating rubber can permeate will not be formed and the wire strands will move individually. When the standard deviation σ of the forming factor exceeds 20%, the form of the steel cord becomes unstable and the tire durability is negatively affected.

Additionally, in this embodiment as well, the wire strand diameter d of the steel cord is preferably from 0.28 to 0.35 mm for the reasons described above.

Moreover, in the present technology, at least one wire strand of the two wire strands of the steel cord is preferably subjected to minor preforming. The reason for this is because the formation of the localized spaces through which the covering rubber can permeate will be facilitated.

In the present technology, dimensions and a form of the minor forming are not particularly limited. Any conventional, known minor forming that is performed in advance on the wire strands of the steel cord can be applied. It is preferable that, for example, the form is helical or wave-like, and a pitch thereof be from ½ to 1/20 of the twisting pitch of the cord.

Note that the minor forming is preferably performed in advance using a forming apparatus.

The pneumatic tire according to the second embodiment of the present technology, in general, is configured as described above.

### EXAMPLES

### Working Example 1

Pneumatic tires having a tire size of 145R12 and provided with two layers of a belt layer in which steel cords (1×2×0.30) having an insertion density of 40 cords/50 mm were manufactured. Specifically, steel cords having: a carbon content of the steel rod from which the steel cord is formed; a degree of final wire drawing of the steel cord; and a twisting length, a twisting angle, a cord force, and a cord strength of the steel cord in the tire that are varied as shown in Table 1 were used to manufacture seven types of pneumatic tires for Conventional Example 1, Working Examples 1 and 2, and Comparative Examples 1 to 4.

Here, the “degree of final wire drawing” refers to a value calculated according to the formula 2×ln(R1/R2), when a plated wire diameter is R1 and a final wire diameter is R2.

Conventional Example 1 is an example in which a high-tension steel rod having a high carbon content is used as a raw material, wherein, while the cord strength satisfies the range limits of the present technology, the carbon content and the twisting angle do not satisfy the range limits of the present technology. Working Examples 1 and 2 are example in which a steel rod having a low carbon content is used as a raw material, wherein the carbon content and the twisting angle are made to vary within the respective ranges stipulated in the present technology. Comparative Examples 1 to 4 are examples in which, while the carbon content of the steel rod is within the range stipulated in the present technology, the twisting angle or the cord strength is outside the range stipulated in the present technology.

Each of these 7 types of evaluatory tires was subjected to the following tests and tire durability was measured. The results were recorded in Table 1.

The tires of Working Examples 1 and 2 maintained durability greater than or equal to that of the tire of the Conventional Example. The cord force of Comparative Example 1 declined, and the ductility of Comparative Example 2 declined. Additionally, point contact breakage occurred in Comparative Example 3, and the form in Comparative Example 4 became unstable.

### Tire Durability

Each of the evaluatory tires was assembled on a size 12×4.00B rim and inflated to an air pressure of 170 kPa. A load was set to 3.2±2.1 kN, a slip angle was set to 0±4°, and the assembled tires were run at a speed of 25 km/h on a rotating drum having a diameter of 1,707 mm while varying the rectangular waves of the load and the slip angle at 0.067 Hz. This running test was performed until the evaluatory tire failed, and the running distance was measured. The results were recorded as index values with the value of the running distance of Conventional Example 1 being 100. A larger index value indicates superior tire durability.

TABLE 1

| | | | Working | Working | | | | |
|---|---|---|---|---|---|---|---|---|
| | | Conventional | Example | Example | Comparative | Comparative | Comparative | Comparative |
| | | Example 1 | 1 | 2 | Example 1 | Example 2 | Example 3 | Example 4 |
| Steel rod | Carbon content | 0.82 | 0.72 | 0.62 | 0.72 | 0.72 | 0.72 | 0.72 |
| | (%) | | | | | | | |
| Steel cord | Degree of | 3.5 | 3.8 | 4.2 | 3.5 | 4.4 | 3.8 | 3.8 |
| | final wire | | | | | | | |
| | drawing | | | | | | | |
| Steel cord | Twisting length | 14.0 | 20.0 | 25.0 | 20.0 | 20.0 | 14.0 | 40.0 |
| (in tire) | (mm) | | | | | | | |
| | Twisting angle | 3.9 | 2.7 | 2.2 | 2.2 | 2.7 | 3.9 | 1.3 |
| | (°) | | | | | | | |
| | Cord force | 450 | 450 | 450 | 400 | 500 | 445 | 455 |
| | (N) | | | | | | | |
| | cord strength | 3183 | 3183 | 3183 | 2829 | 3537 | 3148 | 3218 |
| | (MPa) | | | | | | | |
| Evaluation | Tire durability | 100 | 101 | 102 | 98 | 99 | 97 | 99 |
| | (index value) | | | | | | | |

### Working Example 2

Effectiveness of a pneumatic radial tire of the second embodiment of the present technology was investigated, wherein the pneumatic radial tire is a tire for use on a passenger vehicle having a tire size of 145R12 and a rim size of 12×4.00B.

A 1×2×0.3HT steel cord was used as the steel cord of the first and second belts 22a and 22b of the belt layer 22 of the tire 10 illustrated in FIG. 1, and the cord insertion density was 40.0 cords/50 mm.

As shown in Table 2, the carbon content of the steel rod from which the steel cord is formed; the degree of final wire drawing of the steel cord; the twisting length, twisting angle, cord force, and cord strength of the steel cord in the tire; and the average value and the standard deviation (AVG,σ) of the forming factor were varied so as to manufacture evaluatory tires of Conventional Example 2, Working Examples 3 and 4, and Comparative Example 5, and the tire durability of each of these evaluatory tires was measured. The results were recorded in Table 2.

In Table 2, the carbon content of the steel rod, the degree of final wire drawing of the steel cord; the twisting length, twisting angle, cord force, and cord strength of the steel cord in the tire; and the average value and the standard deviation (AVG,σ) of the forming factor of Conventional Example 2 were, respectively, 0.82%, 3.5; 14.0 mm, 3.9 degrees, 450 N, 3183 MPa; and 96% and 2%. While the average values (AVG) of the cord strength and the forming factor satisfied the range limits of the present technology, the standard deviations σ of the carbon content, twisting angle, and forming factor, did not satisfy the range limits of the present technology. The tire durability of the tires of Working Examples 3 and 4 and Comparative Example 5 were recorded as index values with the index value of the tire of Comparative Example 2 being 100.

Here, the degree of final wire drawing of the steel cord was calculated according to the method described in Working Example 1 and the twisting length, twisting angle, cord force, and cord strength of the steel cord in the tire; and the average value and the standard deviation (AVG,σ) of the forming factor were calculated according to the methods described above.

Additionally, tire durability was calculated according to the same method as in Working Example 1.

A running test was performed until the evaluatory tires failed, and the running distances were measured and recorded as index values with the index value of Comparative Example 2 being 100.

TABLE 2

| | | | Conventional | Working | | Comparative |
|---|---|---|---|---|---|---|
| | | | Example | Examples | | Example |
| | | | 2 | 3 | 4 | 5 |
| Steel rod | Carbon content (%) | | 0.82 | 0.72 | 0.62 | 0.72 |
| Steel cord | Degree of final | | 3.5 | 3.8 | 4.2 | 3.8 |
| | wire drawing | | | | | |
| Steel cord | Twisting length (mm) | | 14.0 | 20.0 | 25.0 | 40.0 |
| (in tire) | Twisting angle (degree) | | 3.9 | 2.7 | 2.2 | 1.3 |
| | Cord force (N) | | 450 | 450 | 450 | 450 |
| | Cord strength (MPa) | | 3183 | 3183 | 3183 | 3183 |
| | Forming | AVG | 96 | 101 | 99 | 103 |
| | factor (%) | σ | 2 | 10 | 16 | 9 |

| | | | | |
|---|---|---|---|---|
| Tire durability | 100 | 102 | 105 | 99 |

The evaluatory tires of Working Examples 3 and 4 have twisting lengths of the steel cord of 20.0 mm and 25.0 mm, respectively, and both satisfy the range limits of the present technology with relation to the carbon content of the steel rod; the twisting angle and cord strength of the steel cord; and the average value and the standard deviation (AVG,σ) of the forming factor. Therefore, as is clear from Table 2, Working Examples 3 and 4 had recorded index values of 102 and 105, respectively, displaying enhanced tire durability over that of Conventional Example 1, the evaluatory tire of which indexed a tire durability of 100. Additionally, it is clear that the tire durability of the evaluatory tires of Working Examples 3 and 4 was further enhanced, even when compared to Working Examples 1 and 2.

In contrast, in Comparative Example 5, the twisting angle was 1.3, which is less than the range limits of the present technology. Therefore, when the twisting length was set to a pitch of 40 mm, the form became unstable, and tire durability declined to an index value of 99, resulting in an index value worse than that of Comparative Example 2.

Thus, the effectiveness of the present technology is clear in that, compared to Comparative Example 5, the Working Examples of the present technology are more effective in enhancing tire durability.

The pneumatic tire of the present technology was described in detail above. However, it should be understood that the present technology is not limited to the above embodiments, but may be improved or modified in various ways so long as these improvements or modifications remain within the scope of the present technology.

### INDUSTRIAL APPLICABILITY

With the pneumatic tire of the present technology, productivity can be enhanced while fatigue resistance of the steel cord used in the reinforcing layer is maintained. Furthermore, the fatigue resistance of the steel cord can be enhanced, which leads to the tire durability being enhanced. Therefore, the pneumatic tire of the present technology is suitable for use as a pneumatic tire for a vehicle, and particularly as a radial tire for a vehicle.

### REFERENCE NUMERALS

10 Pneumatic tire (tire)
12 Tread portion
14 Shoulder
16 Sidewall portion
18 Bead portion
20 Carcass layer
22 Belt layer
22a Inner side belt layer
22b Outer side belt layer
24 Belt cover layer
26 Side wall reinforcing layer
28 Bead core
30 Bead filler
32 Tread rubber layer
34 Side wall rubber layer
36 Rim cushion rubber layer
38 Inner liner rubber layer
40, 50 Steel cord
42, 52 Wire strand (strand)
44 Brass plating layer

1. A pneumatic tire comprising a reinforcing layer wherein a steel cord having a 1×2 construction formed by twisting two wire strands together is used, wherein
a carbon content of the steel cord is from 0.60 to 0.75%, a strength of the steel cord in the tire is from 2,900 to 3,500 MPa, and a twisting angle of the steel cord is from 1.5 to 3.0°.

2. The pneumatic tire according to claim 1, wherein a thickness of a brass plating layer formed on an outer surface of the wire strands of the steel cord is from 0.25 to 0.32 μm.

3. The pneumatic tire according to claim 1, wherein a diameter of the wire strands of the steel cord is from 0.28 to 0.35 mm.

4. The pneumatic tire according to claim 1, wherein a twisting length of the steel cord is from 18 to 40 mm.

5. The pneumatic tire according to claim 1, wherein the reinforcing layer is a belt layer and/or a side wall reinforcing layer.

6. The pneumatic tire according to claim 1, wherein an average value of a forming factor of the steel cord is from 95 to 105% and a standard deviation σ is from 5 to 20%.

7. The pneumatic tire according to claim 6, wherein at least one strand of the two wire strands of the steel cord is subjected to minor forming.

8. The pneumatic tire according to claim 1, wherein the pneumatic tire is a pneumatic radial tire.

9. The pneumatic tire according to claim 2, wherein a diameter of the wire strands of the steel cord is from 0.28 to 0.35 mm.

10. The pneumatic tire according to claim 2, wherein a twisting length of the steel cord is from 18 to 40 mm.

11. The pneumatic tire according to claim 3, wherein a twisting length of the steel cord is from 18 to 40 mm.

12. The pneumatic tire according to claim 2, wherein the reinforcing layer is a belt layer and/or a side wall reinforcing layer.

13. The pneumatic tire according to claim 3, wherein the reinforcing layer is a belt layer and/or a side wall reinforcing layer.

14. The pneumatic tire according to claim 4, wherein the reinforcing layer is a belt layer and/or a side wall reinforcing layer.

15. The pneumatic tire according to claim 2, wherein an average value of a forming factor of the steel cord is from 95 to 105% and a standard deviation σ is from 5 to 20%.

16. The pneumatic tire according to claim 3, wherein an average value of a forming factor of the steel cord is from 95 to 105% and a standard deviation σ is from 5 to 20%.

17. The pneumatic tire according to claim 4, wherein an average value of a forming factor of the steel cord is from 95 to 105% and a standard deviation σ is from 5 to 20%.

18. The pneumatic tire according to claim 5, wherein an average value of a forming factor of the steel cord is from 95 to 105% and a standard deviation σ is from 5 to 20%.

19. The pneumatic tire according to claim 2, wherein the pneumatic tire is a pneumatic radial tire.

20. The pneumatic tire according to claim 3, wherein the pneumatic tire is a pneumatic radial tire.
